(19) United States
(12) Patent Application Publication
(10) Pub. No.: US 2006/0271368 A1
(43) Pub. Date: Nov. 30, 2006

(54) Voice interface for consumer products

(76) Inventors: Yishay Carmiel, Herzylia (IL); Asaf Carmiel, Haifa (IL)

Correspondence Address: DR. MARK FRIEDMAN LTD.;c/o Bill Polkinghorn, 9003 Florin Way, Upper Marlboro, MD, 20772, US

(21) Appl. No.: 11/136,518

(22) Filed: May 25, 2005

(51) Int. Cl. G10L 21/00

(52) U.S. Cl. 704/275

(57) ABSTRACT

A method for generating voice interface for appliances which may be performed by a manufacturer of the appliance. The manufacturer selects a programmable device for controlling the appliance, the programmable device having resources of less than 9 kilobytes of random access memory and capable of less than 41 million instructions per second. The manufacturer is further provided with an application development kit for building an application for the voice interface including a speech recognition module. The manufacturer programs the programmable device with the application. Preferably, while programming and running the application, the application includes multiple stages and for each stage a different set of open words are recognizable by the speech recognition module. Preferably, the open words are recognized by the speech recognition module, solely in response to a previously stored question posed to a user of the appliance.

### FIELD AND BACKGROUND OF THE INVENTION

The present invention relates to consumer appliances and, more particularly, to a voice interface to improve the human interaction with consumer appliances.

Modern man is inundated with machines and appliances of all kinds during daily life. The user interface in most appliances commonly includes buttons, dials or keypads. However, a simpler, more natural and oftentimes more convenient interface between man and machine is human speech. Thus there is a need for and it would be advantageous to have a voice interface for home appliances and consumer electronic products.

Speech recognition has been developing over the past decades and various methodologies have been introduced for automated speech recognition (ASR), including constrained grammar recognition and natural language recognition.

Speech recognition technology is used for telephone applications like travel booking and information, financial account information, customer service call routing, and directory assistance. Using constrained grammar recognition, such applications can achieve high accuracy. Speech recognition systems optimized for telephone applications can often supply information about the confidence of a particular recognition, and if the confidence is low, the system triggers the application to prompt callers to confirm or repeat their request (for example “I heard you say ‘billing’, is that right?”).

Grammar constrained recognition constrains the possible recognized phrases to a small or medium-sized formal grammar of possible responses, which is typically defined using a grammar specification language. This type of recognition works best when the speaker is providing short responses to specific questions, like yes-no questions; picking an option from a menu; selecting an item from a well-defined list, such as financial securities like stocks and mutual funds or names of airports; or reading a sequence of numbers or letters, like an account number.

The grammar specifies the most likely words and phrases a person will say in response to a prompt and then maps those words and phrases to a token, or a semantic concept. For example, a yes-no grammar might map “yes”, “yeah”, “uh-huh”, “sure”, and “okay” to the token “yes” and “no”, “nope”, “nuh-uh”, and “no way dude!” to the token “no”. A grammar for entering a 10-digit account number would have ten slots each of which contain one digit which could be zero through nine, and result from the grammar would be the 10-digit number that was spoken. If the speaker says something that doesn't match an entry in the grammar, recognition will fail. Typically, if recognition fails, the application will re-prompt users to repeat what they said, and recognition will be tried again. If a telephone answering system using grammar constrained recognition is well designed and is repeatedly unable to understand the user (typically due to the caller misunderstanding the question, having a thick accent, mumbling, or speaking over a large amount of background noise or interference), the telephone answering system should be backed up by another input method or transfer the call to an operator. Callers who are asked to repeat themselves over and over quickly become frustrated and agitated.

Natural language recognition allows the speaker to provide natural, sentence-length responses to specific questions. Natural language recognition uses statistical models. The general procedure is to store a large number of typical responses, with each response matched up to a token or concept. For example for the concept “forward my call to the billing department”, you would want to recognize sentences like “I have a problem with my bill”, “I was charged incorrectly”, “How much do I owe this month”, etc. It is difficult to create large, rich grammars that consider the context in which the words are said. In addition, as a grammar gets very large, the chances of having similar sounding words in the grammar greatly increases.

Some systems use a hybrid of constrained grammar and natural language recognition that permits sentence-length responses to specific questions, but ignores the irrelevant part of the sentence using a natural language “garbage model”. Combining this approach with prompts that encourage short answers can be effective at maximizing the accuracy and correctness of recognition.

Speech recognition is performed by inputting a speech signal, typically using a microphone and digitizing the signal. The speech signal is input into a circuit including a processor which performs a Fast Fourier transform (FFT) using any of the known FFT algorithms. Practically, the input digitized voiced signal in the time domain is placed in an input data buffer. The FFT algorithm and the processing is simplified if performed “out-of-place” i.e. if an output buffer is distinct from the input buffer. For example, the Stockham auto-sort algorithm (Stockham, 1966) performs every stage of the FFT out-of-place, typically writing back and forth between two arrays, transposing one “digit” of the indices with each stage.

An “in-place” FFT algorithm uses the same data buffer for the input data and the output (frequency domain) data. A typical strategy for “in-place” algorithms without auxiliary storage and without separate digit-reversal passes involves small matrix transpositions (which swap individual pairs of digits) at intermediate stages, which can be combined with the radix butterflies to reduce the number of passes over the data (Johnson & Burrus, 1984; Temperton, 1991; Qian et al., 1994; Hegland, 1994).

After performing FFT, the frequency domain data is generally filtered e.g. Mel filtering to correspond to the way human speech is perceived. A sequence of coefficients are used to generate voice prints of words or phonemes based on Hidden Markov Models (HMMs). A hidden Markov model (HMM) is a statistical model where the system being modeled is assumed to be a Markov process with unknown parameters, and the challenge is to determine the hidden parameters, from the observable parameters, based on this assumption. The extracted model parameters can then be used to perform speech recognition. Having a model which gives the probability of an observed sequence of acoustic data given a word phoneme or word sequence enables working out the most likely word sequence.

### REFERENCES

Rabiner, Lawrence, Biing-Hwang Juang Fundamentals of Speech Recognition, Prentice-Hall
James W. Cooley and John W. Tukey, “An algorithm for the machine calculation of complex Fourier series,” Math. Comput. 19, 297-301 (1965).
T. G. Stockham, “High speed convolution and correlation”, Spring Joint Computer Conference, Proc. AFIPS 28, 229-233 (1966).
H. W. Johnson and C. S. Burrus, “An in-place in-order radix-2 FFT,” Proc. ICASSP, 28A.2.1-28A.2.4 (1984).
C. Temperton, “Self-sorting in-place fast Fourier transform,” SLAM J. Sci. Stat. Comput. 12 (4), 808-823 (1991).
Qian, C. Lu, M. An, and R. Tolimieri, “Self-sorting in-place FFT algorithm with minimum working space,” IEEE Trans. ASSP 52 (10), 2835-2836 (1994).
M. Hegland, “A self-sorting in-place fast Fourier transform algorithm suitable for vector and parallel processing,” Numerische Mathematik 68 (4), 507-547 (1994).
Matteo Frigo and Steven G. Johnson: FFTW, http://www.fftw.org/. A free (GPL) C library for computing discrete Fourier transforms in one or more dimensions, of arbitrary size, using the Cooley-Tukey algorithm. Also M. Frigo and S. G. Johnson,”
   All references are hereby incorporated as if entirely set forth herein.
   Background benefits from:
   http://en.wikipedia.org/wiki//Speech_recognition,
   http://en.wikipedia.org/wiki/Cooley-Tukey_FFT_algorithm

### SUMMARY OF THE INVENTION

The term “programmable device” as used herein refers to a microprocessor or a dedicated device manufactured using any technology such as ASIC, FPGA or CPLD. The terms “microprocessor” and “programmable device” are used herein interchangeably.

The term “open words” as used herein refers to a set of words recognizable during a specific stage during a speech recognition scenario.

The term “in-place FFT algorithm” as used herein refers to any mixed radix or real mixed radix algorithm.

The term “generic” as used herein means that any voice interface application can be applied to multiple programmable devices (or device family) typically by integrating appropriate libraries available in the application development kit of the present invention.

The terms “manufacturer” and “developer” are used herein interchangeably and refers to the entity that develops an appliance for manufacturing the appliance.

The term “manufacturer independent” refers to a property of the application kit of the present invention, that voice interface applications may be developed for multiple types or appliances and/or multiple manufacturers of the same type of appliance.

According to the present invention there is provided a method for generating voice interface for appliances which may be performed by a manufacturer of the appliance. The manufacturer is provided with a programmable device for controlling the appliance, the programmable device having resources of less than 9 kilobytes of random access memory and capable of less than 41 million instructions per second. The manufacturer is further provided with an application development kit for building an application for the voice interface including a speech recognition module. The manufacturer programs the programmable device with the application. When the application is run, such as by a user of the appliance, the application operates the appliance. Preferably, while programming and running the application, the application includes multiple stages and for each stage a different set of open words are recognizable by the speech recognition module. Preferably, the open words are recognized by the speech recognition module, solely in response to a previously stored question posed to a user of the appliance. Preferably, the speech recognition module uses supervised recognition algorithms. Preferably, while running the application, a speech recognition calculation begins on-the-fly, as soon as speech of a user is detected. Preferably, resources of the programmable device include less than 5 kilobytes of random access memory. Preferably, the speech recognition module includes an in-place algorithm for computing a fast Fourier transform. Preferably, programming is performed using assembly code optimized for speed. Preferably, the programmable device is selected by the manufacturer from multiple different programmable device families. Preferably, code is portable between a plurality of programmable device families.

According to the present invention there is provided a voice interface application development kit provided to a manufacturer of a consumer appliance for integrating a voice interface for the consumer appliance. The development kit includes an application generator which receives as inputs from the manufacturer multiple stages of a voice interface application, and for each stage a question is posed to a user of the appliance and a limited number of open words are recognizable in response to said question. The kit further includes a data base of words from which the open words are selected by the manufacturer, the data base further includes models for recognizing the words. The manufacturer selects a programmable device from programmable device families and builds a voice interface circuit included in the appliance by programming the programmable device with code which implements an application generated with the application generator. Preferably, the number of open words is less than twenty, limited by resources of the programmable device. Preferably, a portion of the code is generic and supported by all the programmable device families. The kit further includes a voice output module which poses questions to the user by controlling part of the voice interface circuit. Preferably, the kit further includes a speech recognition module which applies an in-place fast Fourier transform algorithm to voice input data received in the appliance. Preferably, the speech recognition module applies supervised recognition algorithms.

According to the present invention there is provided a program storage device readable by a machine, tangibly embodying a program of instructions executable by the machine to perform a method for building a voice interface circuit which controls an appliance. The method is performed by a manufacturer of the appliance. The method includes programming a programmable device in multiple stages of a voice interface application. For each stage a question is posed to a user of the appliance and a limited number of open words are recognizable in response to the question. The programmable device included in the voice interface circuit, is selected from a plurality of programmable device families and a portion of the programming is generic to all programmable device families and a portion of the programming is specific to the family of the programmable device. Preferably, the programmable device includes resources of less than 9 kilobytes of random access memory and capable of less than 41 million instructions per second. wherein said programmable device includes resources of less than 5 kilobytes of random access memory and capable of less than 21 million instructions per second.

### BRIEF DESCRIPTION OF THE DRAWINGS

The invention is herein described, by way of example only, with reference to the accompanying drawings, wherein:

FIG. 1 is a prior art drawing of a system and method for providing a voice interface in a consumer appliance, according to an embodiment of the present invention;

FIG. 2 is a drawing of the software modules in an application development kit, according to an embodiment of the present invention; and

FIG. 3 is a flow drawing showing stages of a voice interface application, according to an embodiment of the present invention.

### DESCRIPTION OF THE PREFERRED EMBODIMENTS

The present invention is of a system and method of creating a voice interface for home appliances. By way of introduction, consider the ubiquitous clock-radio or alarm clock used to arouse us in the morning. The standard interface to the clock-radio includes several buttons. Typically, both time and alarm are set by cycling through digits by pushing one or more of the buttons. This process is repeated to set hours and minutes. The alarm time is similarly set. Those who do not have a regular schedule, for instance, are required to repeat the process of re-setting the alarm time several times during the week The standard clock-radio interface is not generally convenient for individuals who share bedrooms when each individual has a different schedule. Improved clock/radio/alarm interfaces can be purchased, however, given a plethora of buttons many people only learn the most basic functions.

As a consumer appliance, the clock/radio/alarm is very cost sensitive. Each additional feature requires an additional button adding cost and size to the unit. Alternatively, the feature may be multiplexed with existing buttons adding additional complexity to the human interface.

A principal intention of the present invention is to provide a voice interface to home appliances, such as a clock-radio. The voice interface, according to an embodiment of the present invention is implemented with minimal additional cost, on the order of a few dollars by requiring minimal computing and data storage resources such as is available using a small 16 bit microprocessor, (for instance TMS320LF2401A with 2 kilobytes of random access memory and 40 Mhz (Texas Instruments Inc., 12500 TI Boulevard, Dallas, Tex.) or equivalent processor, i.e. ASIC capable of 20 million instructions per second (MIPS). It should be noted that the programmable device used in embodiments of the present invention has much less resources than processors used in prior-art speech recognition systems, e.g. telephone answering systems.

Another intention of the present invention, is to provide software tools to manufacturers of home appliances for building a voice interface for the appliance. Each manufacturer of consumer appliances may build a voice interface with use of the application kit, of the present invention, according to his own requirements.

Another intention of the present invention is to provide performance, typically speed and recognition accuracy sufficient that the voice interface is convenient to use, Performance is measured both by speed and by accuracy of speech recognition. Speed required for a correct recognition of a response is on the order of 1-2 secs, accuracy of recognition is preferably greater than 95%. Preferably, the performance is sufficient so that a conventional interface is not required as a backup, reducing the overall cost of the consumer appliance.

The principles and operation of a system and method of creating a voice interface for consumer appliances, according to the present invention, may be better understood with reference to the drawings and the accompanying description.

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

It should be noted that awhile the discussion herein is directed to small consumer appliances, the principles of the present invention may be adapted for large appliances, e.g. automobiles or use in non-consumer applications as well.

Further the speech recognition algorithm, such as the algorithm for performing a fast Fourier transform may be any such algorithm known in the art.

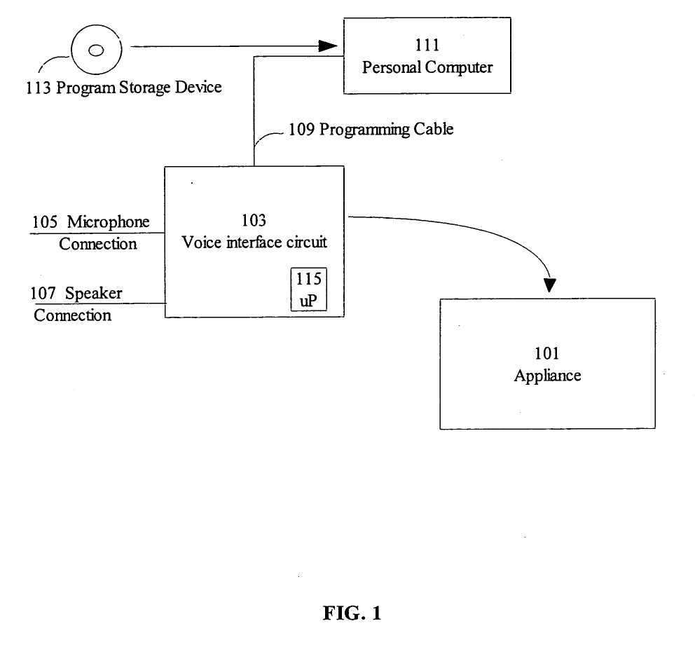

Referring now to the drawings, FIG. 1 illustrates a system and method for providing a voice interface in a consumer appliance 101. Typically, a manufacturer/developer of appliance 101 builds a voice interface circuit 103 as part of consumer appliance 101 under development or an emulation circuit (not shown) which emulates the function of consumer appliance 101 being developed. Voice interface circuit includes a programmable device, e.g. microprocessor 115 with a cable 109 to a personal computer 111 which programs the microprocessor with a voice interface application. Microprocessor 115 has a connection 105 through appropriate circuitry to a microphone and a speaker cable 107 to a speaker (not shown) for voice output from appliance 101. Program storage device, e.g. CDROM 113 is used to load a voice interface application development kit into personal computer 111 for the purpose of building the voice interface for appliance 101.

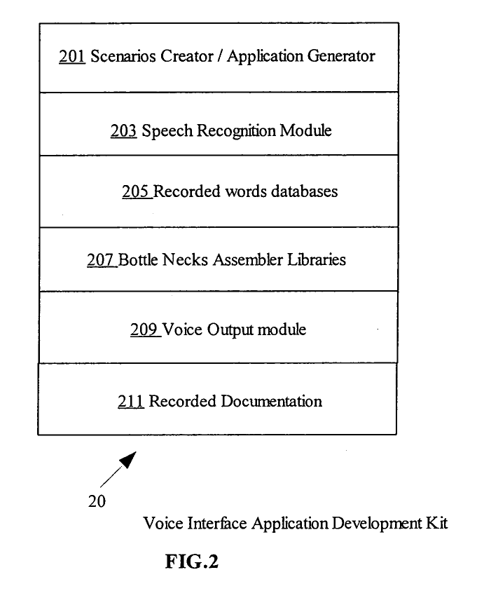

FIG. 2 illustrates a block diagram of software modules included in voice interface application development kit 20, according to the present invention.

Application development kit 20 includes an application generator or scenario creator 201. Application generator 201 is used to generate a series of questions which will be posed to users of appliance 101. Application generator 20 is used to define a set of open words which are valid user responses to the questions posed. When the voice interface is run, models of the open words are stored in random access memory attached to or packaged with microprocessor 115. The number of open words is limited to about ten or 20, when using small programmable device 115, depending on the speed or accuracy required for speech recognition. Preferably, an attempt to use too many open words during any stage of the application results in application generator 201 to generate a warning or error message to the development person (manufacturer) operating application generator 201. Commonly used words are typically provided with voice interface application development kit 20 in a recorded words database 205. Alternatively or in addition, the manufacturer of the appliance may record his own words and build his own recorded word database 205. Application generator 201 is preferably written a generic language, typically ANSI C so that many microprocessor families 115 are supported. The manufacturer/developer may choose microprocessor 115 typically one already used by the manufacturer or already integrated into appliance 101.

Speech recognition module 203 reads the voice data and performs fast Fourier transforms with a butterfly/permutation process and compares the output data, e.g. Mel Frequency Cepstrum coefficients, to the models of open words stored in RAM memory.

Since RAM memory is limited, e.g. to 2K words (or 4 K bytes), fast Fourier transforms (FFT) (and inverse) transforms are preferably performed using an in-place algorithm, storing for instance time domain input voice data and the output frequency domain data in the same array. Since only a real FFT is required, a 256 word data buffer is sufficient if an in-place algorithm is used. The use of an in-place algorithm in includes a penalty in calculation time. In order to increase calculation speed, speech recognition module 203 is written in assembler code optimized for speed. Since assembler code is not typically generic and each programmable device 115 family has its own instruction set, assembler code libraries 207 are included in application development kit 20 to support multiple families of programmable devices 115. In order to further increase speed of calculation, speed recognition calculations are performed “on-the-fly” triggered by the onset of voice reception and do not wait for the word to be fully spoken and received.

Voice interface application development kit 20 further includes a voice output module which records the questions generated by application generator 201 and plays the questions on the speaker of appliance 101 through speaker connection 107. Voice interface development kit further includes an option to record documentation 211 for the manufacturer and/or a user of appliance 101.

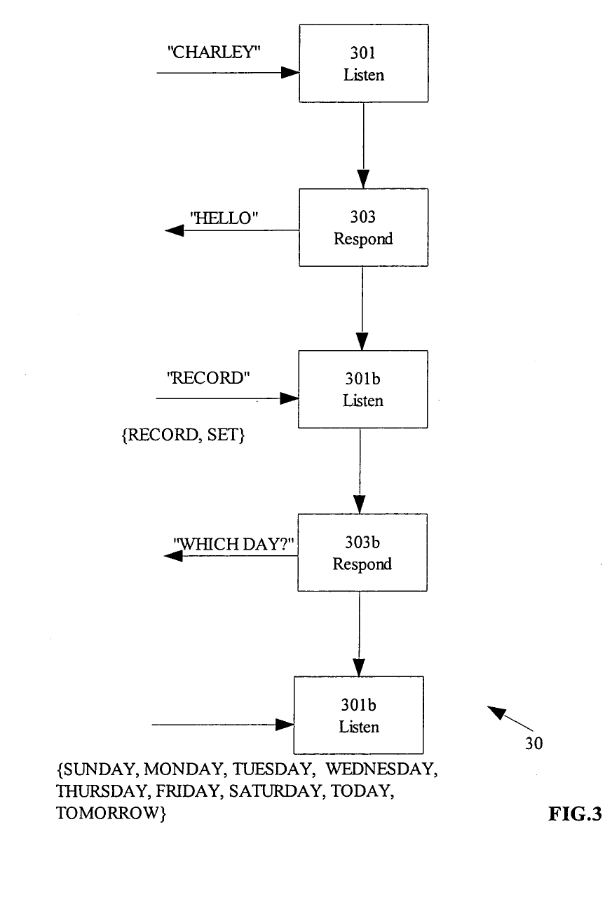

FIG. 3 illustrates a voice interface scenario 30 for a DVD recorder remote control unit. Voice interface scenario 30 may be generated by a manufacturer while developing a voice interface for the DVD recorder control unit. Typically, scenario 30 begins with a listening step 301 as a background process. A person is prompted to speak one or more names name which refer to the control unit, for instance to wake-up DVD from sleep mode. He speaks the name “CHARLEY”. Speech recognition module 203 builds a model of the received name “CHARLEY” and calculates a model and places the model of “CHARLEY” in FLASH memory, attached to programmable device 115. Subsequently, on power up the model of “CHARLEY” is loaded in RAM As scenario 30 proceeds, the person is prompted to enter an opening question and/or response by the control unit. The person chooses the word “HELLO” from recorded words database 205.

Scenario 30 continues with listening step 301b, and enters two open words {RECORD, SET}from recorded words database 205. The word “RECORD” if received is used to initiate a recording, the word “SET” is used to set a parameter in the control unit or DVD recorder. In response to “RECORD”, the control unit is programmed to respond (step 303b) “WHICH DAY?”. In listening step 301c, open words which are valid spoken responses are:

{SUNDAY, MONDAY, TUESDAY, WEDNESDAY, THURSDAY, FRIDAY, TODAY, TOMORROW}

At each stage of scenario 30, the open words relevant to the stage are loaded from ROM and/or FLASH memory to RAM connected to programmable device 115. Scenario 30 continues straightforwardly (not shown in FIG. 3), for instance the control unit asks by playing through the speaker:
“WHAT TIME TO BEGIN?”
   Typically, for this question there are many possible responses. For hours, open words are for instance “ONE” through “TWELVE” with “AM” and “PM” Recognizing minutes includes additional possibilities for instance for 16:30 a user may respond “FOUR THIRTY” or “HALF PAST FOUR”.

At each stage of scenario 30, a limited number of open words is used in order to speed up and facilitate the speech recognition performance without requiring excessive computing resources. According to an embodiment of the present invention, since the manufacturer/developer controls the application he/she can predict the type and order of words the user is expected to say. Alternatively, application generator 201 includes a dedicated module for handling time of day response. For example in scenario 30 when asking: “WHAT TIME TO BEGIN” the the user response is predicted based on the following assumptions:

The first word is usually a number, so open words including models of “one” to “twelve” are placed in memory. The second word (if there is one) can be “fifteen”, “thirty”, “forty-five”, “AM”, “PM”, “O'clock”. The third word can be AM, PM If a number is not, recognized and the user response is perceived as “garbage” and the program loads the word “half” as an open word. If the first word is “Half” then the second word must be “past”. Third word again must be a number from “one” to “twelve”.

By supplying the manufacturer/developer with an application kit, he/she who controls the application can always divide the application into a larger number of stages, maintaining a small number (less than ten or twenty) of open words. Since the number of possibilities is very small, a dedicated recognition algorithm (e.g. a supervised Viterbi algorithm) may be used since the recognition algorithm is dedicated to the specific application and scenario.

By limiting the number of open words at every stage of the speech recognition scenario, the manufacturer/developer empowered with an application generator according to the present invention, can integrate a voice interface using a programmable device of minimal resources and maintain a low cost bill of materials for the consumer appliance. Since we can predict the sentence structure, the first word is a number between “one” and “twelve” and the second word is “AM or “PM” etc. then a special recognition algorithm (e.g. a supervised recognition algorithm) is dedicated for this structure type. The supervised recognition algorithm allows downsizing the number of possibilities and by that achieve greater accuracy. In addition, building a supervised recognition algorithm creates more accuracy to the recognition process.

While the invention has been described with respect to a limited number of embodiments, it will be appreciated that many variations, modifications and other applications of the invention may be made.

What is claimed is:

1. A method for providing a voice interface for an appliance to a manufacturer of the appliance, the method comprising the steps of:
(a) providing a programmable device for controlling the appliance, said programmable device having resources of less than 9 kilobytes of random access memory and capable of less than 41 million instructions per second;
(b) providing an application development kit to the manufacturer for building an application for the voice interface including a speech recognition module;
(c) programming said programmable device with said application, wherein said programming is performed by said manufacturer; and
(d) running said application, thereby operating the appliance.

2. The method, according to claim 1, wherein said running said application includes a plurality of stages, wherein at each stage a different set of open words are recognizable by said speech recognition module.

3. The method, according to claim 2, wherein said open words are recognized by said speech recognition module, solely in response to a previously stored question posed to a user of the appliance.

4. The method, according to claim 2, wherein said speech recognition module uses at least one supervised recognition algorithm.

5. The method, according to claim 1, while said running said application, a speech recognition calculation begins on-the-fly, as soon as speech of a user is detected.

6. The method, according to claim 1, wherein said resources include less than 5 kilobytes of random access memory.

7. The method, according to claim 1, wherein said speech recognition module includes an in-place algorithm for computing a fast Fourier transform.

8. The method, according to claim 1, wherein at least a portion of said programming is performed using assembly code optimized for speed.

9. The method, according to claim 1, wherein said providing a programmable device is performed by said manufacturer, wherein said programmable device is selected from a plurality of different programmable device families.

10. The method, according to claim 1, wherein at least a portion of the code for said programming is portable between a plurality of programmable device families.

11. A voice interface application development kit provided to a manufacturer of a consumer appliance for integrating a voice interface for the consumer appliance, the development kit comprising:
(a) an application generator which receives as inputs from the manufacturer a plurality of stages of a voice interface application, wherein for each stage a question is posed to a user of the appliance and a limited number of open words are recognizable in response to said question; and
(b) a data base of words from which said open words are selected by the manufacturer, said data base further including models for recognizing said words;
wherein the manufacturer selects a programmable device from a plurality of programmable device families and builds a voice interface circuit included in the appliance by programming said programmable device with code which implements an application generated with said application generator.

12. The kit, according to claim 11, wherein said number of open words is less than twenty limited by resources of said programmable device.

13. The kit, according to claim 11, wherein at least a portion of said code is generic and supported by all said programmable device families.

14. The kit, according to claim 11, further comprising:
(d) a voice output module which poses said question to said user by controlling a portion of said voice interface circuit.

15. The kit, according to claim 11, further comprising:
(d) a speech recognition module which applies an in-place fast Fourier transform algorithm to voice input data received in the appliance.

16. The kit, according to claim 11, further comprising:
(d) a speech recognition module which applies at least one supervised recognition algorithm.

17. A program storage device readable by a machine, tangibly embodying a program of instructions executable by the machine to perform a method for building a voice interface circuit which controls an appliance, the method performed by a manufacturer of the appliance, the method comprising the step of:
programming a programmable device in a plurality of stages of a voice interface application, wherein for each stage a question is posed to a user of the appliance and a limited number of open words are recognizable in response to said question;
wherein said programmable device, included in the voice interface circuit, is selected from a plurality of programmable device families and at least a portion of said programming is generic to all said programmable device families and at least a portion of the programming is specific to the family of said programmable device.

18. The program storage device, according to claim 17, wherein said programmable device includes resources of less than 9 kilobytes of random access memory and capable of less than 41 million instructions per second.

19. The program storage device, according to claim 17, wherein said programmable device includes resources of less than 5 kilobytes of random access memory and capable of less than 21 million instructions per second.
